(19) United States
(12) Patent Application Publication
(10) Pub. No.: US 2022/0000091 A1
(43) Pub. Date: Jan. 6, 2022

(54) HORSESHOE NAIL AND METHOD FOR MANUFACTURING SUCH HORSESHOE NAIL

(71) Applicant: Kerckhaert Hoefijzerfabriek B.V., Vogelwaarde (NL)

(72) Inventor: Michiel Petrus M. Kerckhaert, Moerbeke (BE)

(73) Assignee: Kerckhaert Hoefijzerfabriek B.V., Vogelwaarde (NL)

(21) Appl. No.: 17/365,794

(22) Filed: Jul. 1, 2021

(30) Foreign Application Priority Data
Jul. 2, 2020 (NL) 2025980

(51) Int. Cl. A01L 1/00; B21G 3/00; C21D 9/00; C21D 1/18; C21D 1/42

(52) U.S. Cl. CPC A01L 1/00; B21G 3/005; C21D 2221/01; C21D 1/18; C21D 1/42; C21D 9/0068

(57) ABSTRACT

A horseshoe nail for nailing a horseshoe to a hoof. The horseshoe nail is made from steel with a carbon weight percentage between 0.18 and 0.25. The horseshoe nail contains a shank with a tip at one end and a widened head at the other end. The head is at least hardened over a part of its length from its free end. The shank is not hardened over its entire or almost entire length from the tip.

### CROSS-REFERENCE TO RELATED APPLICATIONS

The present application claims priority to Netherlands Patent Application No. 2025980 filed on Jul. 2, 2020, which is incorporated herein by reference in its entirety.

### TECHNICAL FIELD

The present disclosure relates to a hardened horseshoe nail for nailing a horseshoe under a hoof of a hoofed animal.

### BACKGROUND

It is already known that horseshoe nails are used for nailing a horseshoe under a horse's hoof.

Typically, horseshoes have a curved form with two branches ending in a free end at the back and which are provided with grooves with nail holes in the bottom through which the farrier drives nails into the horse's hoof in the known way.

Traditionally, a horseshoe nail has a shank with a tip at one end and a broadened head at the other end, whereby the heads of the horseshoe nails are partly hidden in the grooves and partly protruding from underneath the horseshoe when the hoof has just been shod.

Furthermore, it is generally known that horseshoe nails are made from steel such as for example steel CHIT or steel 1010A or steel Q235.

A disadvantage of horseshoe nails made from said type of steel is that due to their low carbon content, they are relatively soft, which means that the heads of horseshoe nails wear off relatively quickly and the horseshoe nails can suddenly break off.

Additionally, said protruding section of said heads wears off quite quickly when walking, after just a few days already, and then the wear occurs on the underside of the horseshoe that is in contact with the ground.

Particularly in the case of race horses, which are shod with aluminium horseshoes, the horseshoes consequently need to be replaced in the relatively short term, which obviously results in extra costs.

### SUMMARY

The purpose of the present disclosure is to provide a solution to the aforementioned and other disadvantages.

To this end the present disclosure aims at a method for hardening a horseshoe nail as well as a hardened horseshoe nail for nailing a horseshoe to a hoof, whereby the horseshoe nail is made from steel with a carbon weight percentage between 0.18 and 0.25, whereby the horseshoe nail contains a shank with a tip at one end and a widened head at the other end and whereby the head is at least hardened over a part of its height from its free end, whereas the shank is not hardened over its entire or almost entire length from the tip.

Thanks to the choice of a type of steel with a carbon weight percentage of 0.18 to 0.25 the horseshoe nail is flexible enough to prevent fractures during shodding and/or during walking, whereas the head can be sufficiently hardened to increase the wear resistance, which when walking provides the advantage that therefore the heads wear off less quickly and the horseshoe is consequently protected from wear for longer and needs to be replaced less often and fewer visits to the farrier are needed.

Additionally, the heads with their protruding section give a certain advantage of grip when walking, such that this advantage is also maintained for a longer period when the heads wear off less quickly. This is advantageous during horse races and in preventing falls resulting in possible injury to the horse and the jockey.

In some embodiments, the head of the horseshoe nail is hardened to a Rockwell scale C (HRC) of 30 or more, or 40 or more.

The head of the horseshoe nail is locally hardened by heating, such as but not exclusively with induction, after which the horseshoe nail is quenched in a liquid such as water, such that the steel is converted into martensite.

An advantage of local heating by induction is that this is a well known technique that can be applied very locally without the rest of the horseshoe nail being heated, such that more specifically the shank and the tip retain the desired properties of the originally chosen type of steel.

In some embodiments, the head of the horseshoe nail is made from carbon steel grade 1022 “American Iron and Steel Institute” with a hardness of 98 for example. Hardness Rockwell B (HRB), hardened to a length of for example 1.9 mm to 3.9 mm lengthways along the free end of the head whereby the mechanical properties of this steel change such that the hardness increases to 30 hardness Rockwell C or more.

The head and the shank of the horseshoe nail are both rectangular according to their cross-section, whereby their width direction corresponds with the longest side of the rectangle.

The present disclosure further relates to a horseshoe in combination with one or more hardened horseshoe nails according to the present disclosure, whereby the horseshoe is provided with one or more grooves with one or more nail holes for one horseshoe nail each, and whereby in a mounted condition the head of the horseshoe nail is partly sunk in the groove and protrudes with its hardened end from the groove.

An advantage of the protruding and hardened end of the head from the groove of the horseshoe is that a horse consequently has more grip when stepping, walking and running, which also increases the horse's safety.

The present disclosure also relates to a method for manufacturing a horseshoe nail as described above, said method comprising the following steps:
providing a horseshoe nail made of steel with a carbon weight percentage between 0.18 and 0.25;
locally heating the section of the head of a horseshoe nail to be hardened;
quenching the head in water or another fluid.

### BRIEF DESCRIPTION OF THE DRAWINGS

With the intention of better showing the characteristics of the present disclosure, an embodiment of a horseshoe nail and a method for manufacturing such horseshoe nail according to the present disclosure is described hereinafter, by way of an example without any limiting nature, with reference to the accompanying drawings wherein:

FIG. 1 schematically shows a front view of a horseshoe nail according to the present disclosure;

FIG. 2 shows a classic horseshoe with only a section of the horseshoe nails;

FIG. 3 shows a cross-section according to line III-III in FIG. 2.

### DETAILED DESCRIPTION

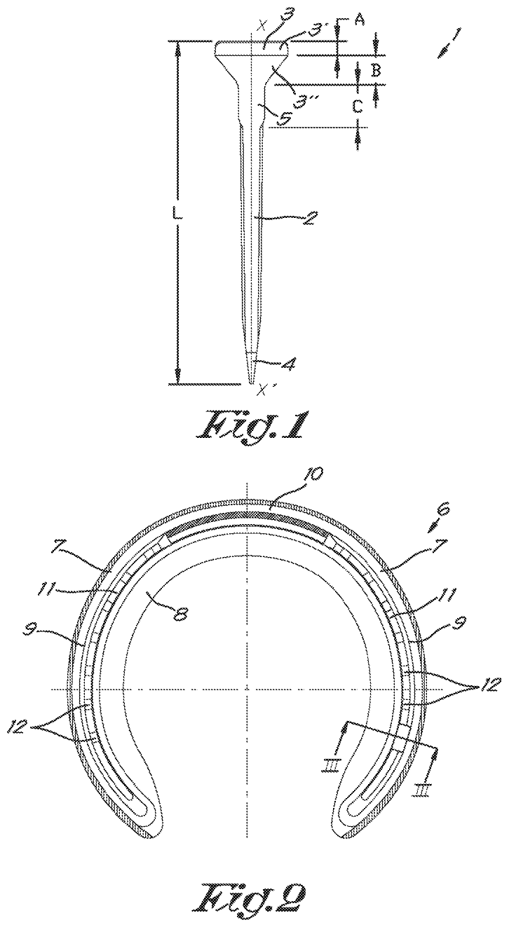

The horseshoe nail 1 shown in FIG. 1 according to its longitudinal direction X-X′ contains a shank 2 with a head 3 at one end and a tip 4 at the other end.

The head 3, from its free end towards the tip 4 of the horseshoe nail 1, first has a section 3′ over length A that is wideningly tapered and subsequently a section 3″ that is narrowingly tapered over a length B up to a straight section 5 of the shank with length C.

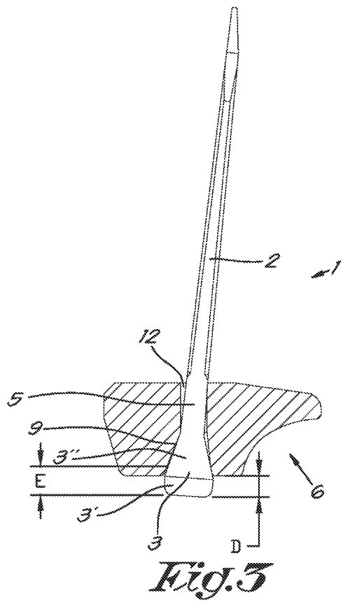

FIG. 2 shows an example of a horseshoe 6 which is made from aluminium or another material such as steel or iron and which has a curved form with two branches 7 on the side and in the underside 8 which is intended for making contact with the ground and is provided with two grooves 9 on either side of the toe section 10 of the horseshoe 6 with nail holes 12 in the base 11 for nailing the horseshoe against the underside of the hoof, whereby in FIG. 2 only one horseshoe nail 1 is shown by way of example.

How the horseshoe nail 1 is mounted through the nail hole is apparent from the cross-section of FIG. 3 which shows that the grooves 9 are narrowingly tapered from the underside 8 toward the base 11, such that the horseshoe nail 1 fits in the groove 9 with the conical section 3″ of the head 3 and the straight section 5 fits in the nail hole 12.

As shown, the head 3 of the horseshoe nail 1 protrudes with a certain length D along the underside 8 from the horseshoe 6.

In some embodiments, the horseshoe nail 1 is made of carbon steel with a hardness of 98 HRB determined by the carbon content in the steel.

According to the present disclosure, the head 3 of the horseshoe nail 1 is locally hardened over a certain length E from the free end of the head 3 of the horseshoe nail 1 which, in some embodiments, is at least equal to the length D of the section of the head 3 of the horseshoe nail 1 protruding from the horseshoe 6.

The length E to where the head 3 is hardened, measured from the free end of the head 3, amounts to 1.9 mm to 3.9 mm.

For hardening the head 3 of the horseshoe nail 1, the end of the head 3 is locally heated for example using induction, after which the horseshoe nail 1 is quenched in a cold fluid such as for example water.

When walking the heads 3 of the horseshoe nails 1 provide a better grip in the ground.

Because the heads 3 are hardened, they will wear off less quickly when walking and the horseshoe 6 made from aluminium or iron or another type of material is protected from wear for longer.

In some embodiments, the horseshoe nail 1 on the level of the shank 2 in cross-section is rectangular, whereby both the width direction of the head and the shank correspond with the longest side of the rectangle. In some embodiments, the head 3 of the horseshoe nail 1 is enlarged in a lateral direction according to the width direction B of the head.

In the example of FIG. 3, the head 3 of the horseshoe nail 1 is rectangular from an axial direction, whereby in this case the head 3 of the horseshoe nail 1 extends with its long rectangle side parallel to the longitudinal direction of the groove 9.

The downward protruding section of the head 3 of the horseshoe nail 1 is locally hardened and therefore longer resistant to wear, which also protects the tread of the horseshoe 6 from wear when walking.

Alternatively, horseshoe nails 1 also exist with a square head which according to the present disclosure can then also be hardened up to a certain length.

The present disclosure is by no means limited to the embodiments described as an example and shown in the figures, however, such method and a horseshoe nail can be realised according to different variants, without departing from the scope of the present disclosure.

What is claimed is:

1. A horseshoe nail for nailing a horseshoe to a hoof, the horseshoe nail is made from steel with a carbon weight percentage between 0.18 and 0.25, whereby the horseshoe nail contains a shank with a tip at one end and a widened head at the other end and whereby the head is at least hardened over a part of its length from its free end, whereas the shank is not hardened over its entire or almost entire length from the tip.

2. The horseshoe nail according to claim 1, wherein the horseshoe nail is made from steel with a carbon weight percentage of at least 0.18.

3. The horseshoe nail according to claim 1, wherein that only the head is hardened up to a length from 1.9 mm to 3.9 mm from its free end.

4. The horseshoe nail according to claim 1, wherein a hardened section of the head has a hardness HRC of 30 or more.

5. The horseshoe nail according to claim 4, wherein a cross-section of both the head and the shank of the horseshoe nail is rectangular, whereby longest sides of both the cross-sections are parallel with each other.

6. A combination of horseshoe and horseshoe nail, whereby the horseshoe is provided with one or more grooves with one or more nail holes in a base whereby in a mounted condition of the horseshoe under a hoof, the nail is partly sunken with its head in the groove with an end protruding from the groove, wherein that the horseshoe nail is a horseshoe nail according to claim 1 in which at least a protruding section of the head is hardened.

7. The combination according to claim 6, wherein that only the protruding section of the head is hardened.

8. A method for making a horseshoe nail with a hardened head according to claim 1, the method comprises the following steps:
providing a horseshoe nail made of steel with a carbon weight percentage between 0.18 and 0.25;
locally heating a section of the head of the horseshoe nail to be hardened; and
quenching the head in water or another fluid.

9. The method according to claim 6, wherein that heating the head of the horseshoe nail uses induction for heating the head locally.

10. The horseshoe nail according to claim 2, wherein that only the head is hardened up to a length from 1.9 mm to 3.9 mm from its free end.

11. The horseshoe nail according to claim 2, wherein a hardened section of the head has a hardness HRC of 30 or more.

12. The horseshoe nail according to claim 3, wherein a hardened section of the head has a hardness HRC of 30 or more.

13. The horseshoe nail according to claim 1, wherein a hardened section of the head has a hardness HRC of 40 or more.

14. The horseshoe nail according to claim 2, wherein a hardened section of the head has a hardness HRC of 40 or more.

15. The horseshoe nail according to claim 3, wherein a hardened section of the head has a hardness HRC of 40 or more.

16. The horseshoe nail according to claim 11, wherein a cross-section of both the head and the shank of the horseshoe nail is rectangular, whereby longest sides of both the cross-sections are parallel with each other.

17. The horseshoe nail according to claim 12, wherein a cross-section of both the head and the shank of the horseshoe nail is rectangular, whereby longest sides of both the cross-sections are parallel with each other.

18. The horseshoe nail according to claim 13, wherein a cross-section of both the head and the shank of the horseshoe nail is rectangular, whereby longest sides of both the cross-sections are parallel with each other.

19. The horseshoe nail according to claim 14, wherein a cross-section of both the head and the shank of the horseshoe nail is rectangular, whereby longest sides of both the cross-sections are parallel with each other.

20. The horseshoe nail according to claim 15, wherein a cross-section of both the head and the shank of the horseshoe nail is rectangular, whereby longest sides of both the cross-sections are parallel with each other.
